(19) United States
(12) Patent Application Publication
(10) Pub. No.: US 2026/0330715 A1
(43) Pub. Date: Oct. 22, 2026

(54) METHOD AND APPARATUS FOR GENERATING EFFECT IMAGE, DEVICE, AND STORAGE MEDIUM

(71) Applicant: Beijing Zitiao Network Technology Co., Ltd., Beijing (CN)

(72) Inventor: Qi YUAN, Beijing (CN)

(21) Appl. No.: 19/104,656

(22) PCT Filed: Aug. 25, 2023
(86) PCT No.: PCT/CN2023/114831

§ 371 Date: Feb. 18, 2025

(30) Foreign Application Priority Data
Aug. 26, 2022 (CN) 202211035725.5

(51) Int. Cl. G06T 11/60; G06T 11/10

(52) U.S. Cl. CPC G06T 11/60; G06T 11/10

(57) ABSTRACT

Embodiments of the disclosure provide a method and apparatus for generating an effect image, a device, and a storage medium. The method includes: obtaining current light source information, a normal map of an original image, and a mask image of the target object, where the light source information includes a light source color, a light source position, and an illumination intensity; generating a target illumination image based on the normal map, the mask image of the target object, and the light source information; and fusing the target illumination image and the original image, to obtain a target illumination effect image.

### CROSS-REFERENCE TO RELATED APPLICATION(S)

The disclosure claims the priority to the Chinese Patent Application No. 202211035725.5, filed with the Chinese Patent Office on Aug. 26, 2022, which is incorporated in its entirety herein by reference.

### FIELD

Embodiments of the disclosure relate to the technical field of image processing, and relate to, for example, a method and apparatus for generating an effect image, a device, and a storage medium.

### BACKGROUND

At present, a function of photographing and video-making of mobile terminals has become one of their functions commonly used. During photographing and video-making in a natural-light scene, a user generally recognizes that a lighting effect of a video shot or made in this scene cannot satisfy the user's individual needs.

### SUMMARY

Embodiments of the disclosure provide a method and apparatus for generating an effect image, a device, and a storage medium, such that an effect image having a lighting effect can be generated, and a display content of the image can be enriched.

In a first aspect, an embodiment of the disclosure provides a method for generating an effect image. The method includes: obtaining current light source information, a normal map of an original image, and a mask image of the target object, where the light source information includes a light source color, a light source position, and an illumination intensity; generating a target illumination image based on the normal map, the mask image of the target object, and the light source information; and fusing the target illumination image and the original image, to obtain a target illumination effect image.

In a second aspect, an embodiment of the disclosure further provides an apparatus for generating an effect image. The apparatus includes: an obtaining module configured to obtain current light source information, a normal map of an original image, and a mask image of the target object, where the light source information includes a light source color, a light source position, and an illumination intensity; a target illumination image generation module configured to generate a target illumination image based on the normal map, the mask image of the target object, and the light source information; and a target illumination effect image obtaining module configured to fuse the target illumination image and the original image, to obtain a target illumination effect image.

In a third aspect, an embodiment of the disclosure further provides an electronic device. The electronic device includes: at least one processor; and a storage apparatus configured to store at least one program which, when executed by the at least one processor, causes the at least one processor to implement the method for generating an effect image according to any one of the embodiments of the disclosure.

In a fourth aspect, an embodiment of the disclosure further provides a storage medium including a computer-executable instruction which, when executed by a processor of a computer, performs the method for generating an effect image according to any one of the embodiments of the disclosure.

### BRIEF DESCRIPTION OF THE DRAWINGS

FIG. 1 is a schematic flow diagram of a method for generating an effect image according to an embodiment of the disclosure;

FIG. 2a is an exemplary diagram of a mask image of the target object according to an embodiment of the disclosure;

FIG. 2b is an exemplary diagram of a second illumination intensity image according to an embodiment of the disclosure;

FIG. 2c is an exemplary diagram of an illumination intensity mask image according to an embodiment of the disclosure;

FIG. 3a is an exemplary diagram of a reverse mask image of the target object according to an embodiment of the disclosure;

FIG. 3b is an exemplary diagram of a first back illumination intensity image according to an embodiment of the disclosure;

FIG. 3c is an exemplary diagram of a first fuzzy mask image according to an embodiment of the disclosure;

FIG. 3d is an exemplary diagram of a second fuzzy mask image according to an embodiment of the disclosure;

FIG. 3e is an exemplary diagram of a fused mask image according to an embodiment of the disclosure;

FIG. 3f is an exemplary diagram of a second back illumination intensity image according to an embodiment of the disclosure;

FIG. 3g is an exemplary diagram of a target back illumination intensity image according to an embodiment of the disclosure;

FIG. 4a is an exemplary diagram of a gray image according to an embodiment of the disclosure;

FIG. 4b is an exemplary diagram of a mask image of the local object according to an embodiment of the disclosure;

FIG. 4c is an exemplary diagram of a smooth gray image according to an embodiment of the disclosure;

FIG. 4d is an exemplary diagram of a smooth local object image according to an embodiment of the disclosure;

FIG. 5 is a schematic structural diagram of an apparatus for generating an effect image according to an embodiment of the disclosure; and

FIG. 6 is a schematic structural diagram of an electronic device according to an embodiment of the disclosure.

### DETAILED DESCRIPTION OF EMBODIMENTS

The terms “include” and “comprise” used herein and their variations are open-ended, that is, “include but not limited to” and “comprise but not limited to”. The term “based on” indicates “at least partly based on”. The term “one embodiment” indicates “at least one embodiment”. The term “another embodiment” indicates “at least one another embodiment”. The term “some embodiments” indicates “at least some embodiments”. Related definitions of other terms will be given in the following description.

It should be noted that concepts such as “first” and “second” mentioned in the disclosure are only used to distinguish different apparatuses, modules or units, and are not used to limit an order or interdependence of functions executed by the apparatuses, modules or units.

It should be noted that modification with “a”, “an” or “a plurality of” mentioned in the disclosure is illustrative rather than limitative, and should be understood by those skilled in the art as “at least one” unless explicitly stated otherwise in the context.

Names of messages or information exchanged between a plurality of apparatuses in the embodiment of the disclosure are only for illustrative purposes, instead of limiting the scope of the messages or information.

It may be understood that before usage of the technical solution disclosed in embodiments of the disclosure, a user has to be informed about a type, a use scope, a use scene, etc. of personal information involved in the disclosure in an appropriate way in accordance with relevant laws and regulations and user authorization has to be obtained.

For example, in response to receiving an active request of a user, prompt information is transmitted to the user, to clearly remind the user that an operation requested by the user is about to require obtaining and using of personal information of the user. Therefore, the user may independently choose to provide or not provide the personal information to software or hardware such as an electronic device, an application, a server or a storage medium that executes an operation of the technical solution of the disclosure based on the prompt information.

As an optional and non-limitative embodiment, in response to receiving the active request of the user, a mode of transmitting the prompt information to the user may be, for example, a pop-up window mode, in which the prompt information may be presented in a character form. In addition, the pop-up window may further carry a selection control allowing the user to choose to “agree” or “disagree” to provide the personal information to the electronic device.

It may be understood that the above process of informing and obtaining user authorization is only illustrative, and does not limit the embodiment of the disclosure. Other modes satisfying relevant laws and regulations may also be applied to the embodiment of the disclosure.

It may be understood that data involved in the technical solution (including, but not limited to, the data itself, and obtaining or using of the data) has to comply with requirements of corresponding laws, regulations and relevant regulations.

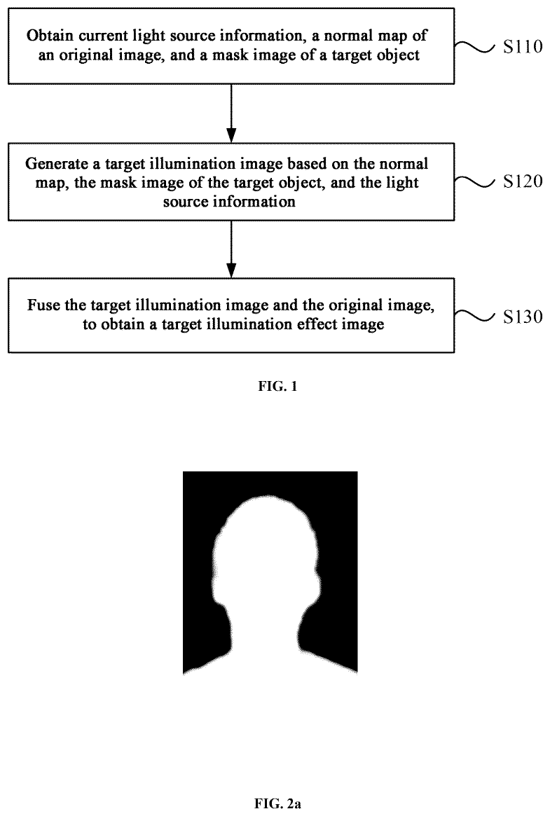

FIG. 1 is a schematic flow diagram of a method for generating an effect image according to an embodiment of the disclosure. The embodiment of the disclosure is suitable for a case of generating an illumination effect image. The method may be executed by an apparatus for generating an effect image. The apparatus may be implemented through at least one of software and hardware, and optionally, may be implemented through an electronic device. The electronic device may be a mobile terminal, a personal computer (PC) end, a server, etc.

As shown in FIG. 1, the method includes the following steps.

At S110, current light source information, a normal map of an original image and a mask image of the target object are obtained.

The light source information includes a light source color, a light source position, and an illumination intensity. A light source may be a virtual light source. The light source position may be changed based on a triggering operation of a user. In the embodiment, an approach for generating the virtual light source may include the following steps that: a virtual object that may be transformable (rotatable, translatable and scalable) is generated, and the virtual object is placed at a world coordinate origin; a transformable light source object is generated and is placed at a position distanced from the world coordinate origin by d in a deviated manner; and the light source object is used as a sub-object of the virtual object, a touch dragging operation is obtained, and coordinate transformation of the touch dragging operation is mapped to coordinate transformation of the virtual object, such that the light source object may be driven to move on a spherical surface through touching, where d may be used as a spherical radius, and the light source object is the virtual light source. The light source color and the illumination intensity may be preset, that is, may be set by a user.

The normal map may be an image composed of normal information of a plurality of pixel points in the original image. The normal information is represented by a three-dimensional vector, that is, a normal vector. Three components of the normal information are mapped to three color channel values, respectively, such that the normal map is obtained. In the embodiment, the normal information of the plurality of pixel points in the original image may be determined through an arbitrary normal estimation algorithm, and the normal map may be generated based on the normal information.

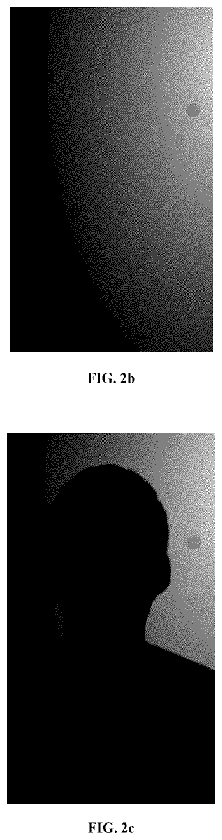

The target object may be any object such as a person, an animal, or a plant, and is not limited herein. A pixel value of a pixel point in the mask image of the target object represents confidence at which the pixel point belongs to the target object. In the embodiment, the way of obtaining the mask image of the target object of the original image may be that: the target object of the original image is identified, confidence at which each pixel point belongs to the target object is obtained, and the mask image of the target object is generated based on confidence of all pixels. A pixel value of the mask image of the target object is a value of 0-1, “0” indicates that a pixel point does not belong to the target object and is black in the mask image of the target object, and “1” indicates that a pixel point belongs to the target object and is white in the mask image of the target object. For example, FIG. 2a is an exemplary diagram of a mask image of the target object in the embodiment. As shown in FIG. 2a, the target object is a person, where a white region is the person, and a black region is a background region.

At S120, a target illumination image is generated based on the normal map, the mask image of the target object, and the light source information.

A color value of a pixel point in the target illumination image represents an illumination color of the pixel point. In the embodiment, the target illumination image is composed of three parts: a target object illumination image, a background region illumination image, and a back illumination image.

In the embodiment, the way of generating the target illumination image based on the normal map, the mask image of the target object, and the light source information may be that: a target object illumination image is generated based on the normal map, the light source information, and the mask image of the target object; a background region illumination image is generated based on the light source information and the mask image of the target object; a back illumination image is generated based on the normal map and the mask image of the target object; and the target object illumination image, the background region illumination image and the back illumination image are fused, to obtain the target object illumination image.

The target object illumination image is generated based on illumination colors of a plurality of pixel points of the target object. The background region illumination image is generated based on illumination colors of a plurality of pixel points of the background region. The back illumination image is generated based on back illumination colors of a plurality of pixel points of an original image.

For example, the process of generating the target object illumination image based on the normal map, the light source information, and the mask image of the target object may be that: an illumination intensity of the pixel point of the target object is determined based on the normal map, the light source information, and the mask image of the target object; the illumination intensity and a light source color are fused, to obtain the illumination color of the pixel point of the target object; and the target object illumination image is generated based on the illumination color of the pixel point of the target object. The process of generating the background region illumination based on the light source information and the mask image of the target object may be that: an illumination intensity of the pixel point of the background region is determined based on the light source information and the mask image of the target object; the illumination intensity and a light source color are fused, to obtain the illumination color of the pixel point of the background region; and the background region illumination image is generated based on the illumination color of the pixel point of the background region. The processing of generating the back illumination image based on the normal map and the mask image of the target object may be that: a back illumination intensity of the pixel point in the original image is determined based on the normal map and the mask image of the target object; the back illumination intensity and the light source color are fused, to obtain the back illumination color of the pixel point; and the back illumination image is generated based on the back illumination color. In the embodiment, the target illumination image is generated based on the target object illumination image, the background region illumination image, and the back illumination image, and different illumination images are generated based on an image region and an illumination direction. Finally, a light-dark alternation effect is presented.

Optionally, the way of generating the target object illumination image based on the normal map, the light source information, and the mask image of the target object may be that: a first illumination intensity image is determined based on the normal map and the light source information; the first illumination intensity image and the light source color are fused, to obtain an initial illumination image; and the initial illumination image and the mask image of the target object are fused, to obtain the target object illumination image.

A pixel value of a pixel point in the first illumination intensity image indicates an illumination intensity of the pixel point. For example, the way of determining the first illumination intensity image based on the normal map and the light source information may be that: intensity attenuation information of a pixel point is determined based on normal information of the normal map and the light source information; the illumination intensity is adjusted based on the intensity attenuation information, to obtain an illumination intensity of the pixel point; and the first illumination intensity image is generated based on illumination intensities of all pixel points. The way of fusing the first illumination intensity image and the light source color may be that: the illumination intensity of the pixel point in the first illumination intensity image is multiplied by the light source color, to obtain the illumination color of the pixel point. The way of fusing the initial illumination image and the mask image of the target object may be that: an illumination color of the initial illumination image is multiplied by a pixel value of a corresponding pixel point in the mask image of the target object, to obtain the target object illumination image. In the embodiment, the initial illumination image and the mask image of the target object are fused, such that the illumination color of the pixel point of the target object may be accurately determined.

Optionally, the way of determining the first illumination intensity image based on the normal map and the light source information may be that: first angle information between an incident light and a pixel point in the original image is determined based on the normal map and the light source information; intensity attenuation information is determined based on a distance between a light source and the pixel point in the original image; the illumination intensity is adjusted based on the first angle information and the attenuation information, to obtain a target intensity of the pixel point; and the first illumination intensity image is generated based on the target intensity of the pixel point.

For example, the process of determining the first angle information between the incident light and the pixel point based on the normal map and the light source information may be that: an illumination direction vector is determined; normal vectors of pixel points in the normal map are extracted; the illumination direction vector and the normal vector of each pixel point are normalized; and point multiplication is performed on the normalized illumination direction vector and normal vectors, to obtain the first angle information. The illumination direction vector may be a vector in which the light source position (indicated by world coordinates) points to a target object center (whose screen coordinates are converted into world coordinates), or a vector in which the light source position points to a target object surface center.

For example, the way of determining the attenuation information based on the distance between the light source and the pixel point in the original image may be that: the light source position is converted from world coordinates to screen coordinates; a distance between the light source position in a screen coordinate system and the pixel point in the original image is computed; and a ratio of the distance to a halo radius is subtracted from 1, to obtain an intermediate result value; and an exponent of an attenuation value is set for the intermediate result value, to obtain the attenuation information. The process of converting the light source position from the world coordinates to the screen coordinates may be that: the world coordinates of the light source are premultiplied by a transformation matrix of a model view projection (MVP), to obtain projection coordinates of the light source, and then components x and components y of the projection coordinates of the light source are linearly transformed, to obtain the screen coordinates of the light source.

For example, the way of adjusting the illumination intensity based on the first angle information and the intensity attenuation information may be that: the illumination intensity is sequentially multiplied by the first angle information and the intensity attenuation information, to obtain the target intensity of the pixel point. The way of generating the first illumination intensity image based on the target intensity of the pixel point may be that: the target intensity is used as the pixel value of the pixel, such that the first illumination intensity image is obtained. In the embodiment, the illumination intensity is adjusted based on the first angle information and the intensity attenuation information, such that accuracy of determining the target intensity of the pixel point can be improved.

In the embodiment, the way of generating the background region illumination image based on the light source information and the mask image of the target object may be that: the distance between the light source and the pixel point in the original image is obtained; a second illumination intensity image is generated based on the distance and the illumination intensity; the second illumination intensity image and the mask image of the target object are fused, to obtain an illumination intensity mask image; and a set color and the light source color are fused based on the illumination intensity mask image, to obtain the background region illumination image.

For example, the way of obtaining the distance between the light source and the pixel point in the original image may be that: the light source position is converted from world coordinates to screen coordinates; and the distance between the light source position in the screen coordinate system and the pixel point in the original image is computed. The way of generating the second illumination intensity image based on the distance and the illumination intensity may be that: exponential operation is performed on the distance; an exponential operation result is subtracted from 1, to obtain an intermediate result; the intermediate result is multiplied by the illumination intensity of the light source, to obtain the target intensity of the pixel point; and then the second illumination intensity image is generated based on the target intensity of the pixel point. For example, FIG. 2b is an exemplary diagram of a second illumination intensity image in the embodiment.

For example, the way of fusing the second illumination intensity image and the mask image of the target object may be that: the pixel value of the corresponding pixel point in the mask image of the target object is subtracted from the pixel value of the pixel point in the second illumination intensity image; in response to the pixel value obtained through subtraction being smaller than 0, the pixel value is adjusted to 0; in response to the pixel value obtained through subtraction being greater than 1, the pixel value is adjusted to 1, to obtain the illumination intensity mask image. For example, FIG. 2c is an exemplary diagram of an illumination intensity mask image in the embodiment. As shown in FIG. 2c, the illumination intensity mask image may be understood as an illumination intensity image obtained by removing the target object from the second illumination intensity image.

The set color may be black, with a corresponding color value of (0, 0, 0). For example, the way of fusing the set color and the illumination color based on the illumination intensity mask image may be that: a pixel value of the illumination intensity mask image is used as a weighting coefficient of the illumination color; a result of subtracting the pixel value of the illumination intensity mask image from 1 is used as a weighting coefficient of the set color; weighted summation is performed on the set color and the illumination color based on the weighting coefficients; and a color value subjected to weighted summation is multiplied by a set value, to obtain a background region illumination color of the pixel point, such that the background region illumination image is obtained. The set value may be set as 0.5. In the embodiment, the determined background region illumination image and target object illumination image have different illumination colors, such that an image presents a light-dark alternation effect.

Optionally, the way of generating the back illumination image based on the normal map and the mask image of the target object may be that: a first back illumination intensity image is determined based on the normal map, the mask image of the target object, and viewing angle information; reverse processing is performed on the mask image of the target object, to obtain a reverse mask image of the target object; a second back illumination intensity image is generated based on the mask image of the target object and the reverse mask image of the target object; the first back illumination intensity image and the second back illumination intensity image are fused, to obtain a target back illumination intensity image; and the target back illumination intensity image and the light source color are fused, to obtain the back illumination image.

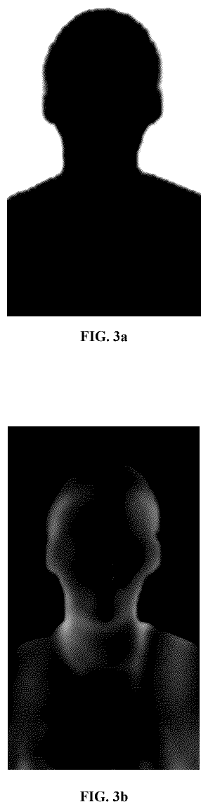

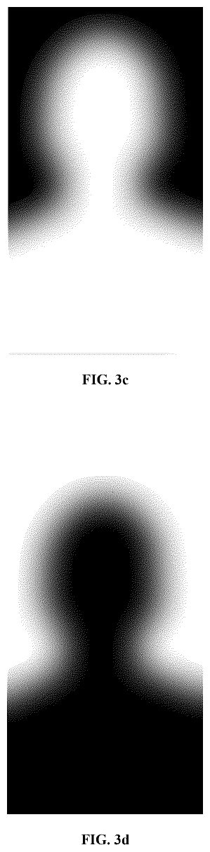

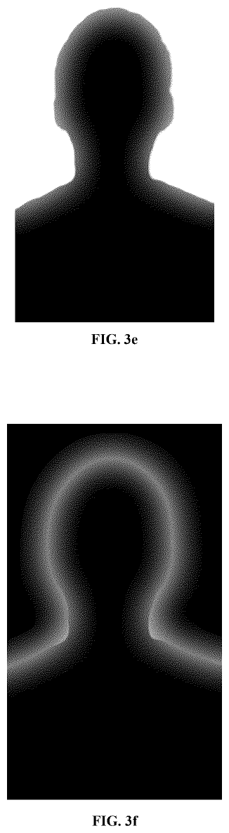

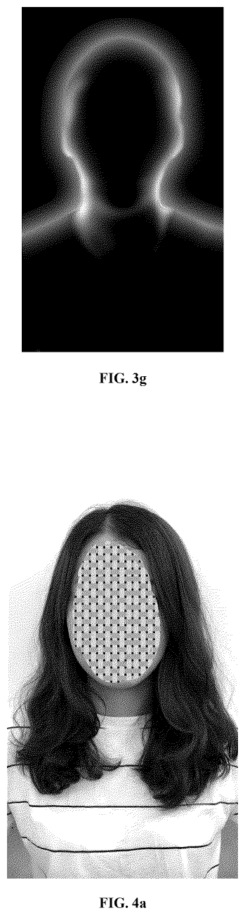

The viewing angle information may be a viewing angle of a virtual camera corresponding to a current image, and may be represented by a vector of a viewing angle direction. The way of performing the reverse processing on the mask image of the target object may be that: the pixel value of each pixel point in the mask image of the target object is subtracted from 1, to obtain the reverse mask image of the target object. For example, FIG. 3a is an exemplary diagram of a reverse mask image of the target object in the embodiment. As shown in FIG. 3a, compared with the mask image of the target object, the reverse mask image of the target object has a black person region and a white background region.

For example, the way of determining the first back illumination intensity image based on the normal map, the mask image of the target object, and the viewing angle information may be that: second angle information between normal information of each pixel point in the normal map and the viewing angle information is determined; an initial back illumination intensity of the pixel point is determined based on the second angle information; an initial back illumination intensity image is generated based on the initial back illumination intensity; and the initial back illumination intensity image and the mask image of the target object are fused, to obtain the first back illumination intensity image.

The process of determining the second angle information between the normal information of each pixel point in the normal map and the viewing angle information may be that: a normal vector and a viewing angle direction vector are normalized separately; point multiplication is performed on the normalized normal vector and viewing angle direction vector, and a point multiplication result between 0 and 1 is taken, such that the second angle information is obtained. The process of determining the initial back illumination intensity of the pixel point based on the second angle information may be that: the second angle information is subtracted from 1; an exponential operation is performed on a subtraction result at a set control intensity; and an exponential operation result is determined as the initial back illumination intensity of the pixel point. The set control intensity may be a value set by a user. The way of fusing the initial back illumination intensity image and the mask image of the target object may be that: the pixel value of the pixel point of the initial back illumination intensity image is multiplied by the pixel value of the corresponding pixel point in the mask image of the target object. For example, FIG. 3b is an exemplary diagram of a first back illumination intensity image in the embodiment. In the embodiment, an intensity image having a contour light effect may be generated.

Optionally, the way of generating the second back illumination intensity image based on the mask image of the target object and the reverse mask image of the target object may be that: fuzzy processing is performed on the mask image of the target object and the reverse mask image of the target object separately, to obtain a first fuzzy mask image and a second fuzzy mask image; the second fuzzy mask image and the reverse mask image of the target object are fused, to obtain a fused mask image; and the fused mask image and the first fuzzy mask image are fused, to obtain the second back illumination intensity image.

The first fuzzy mask image may be an image after fuzzy processing of the mask image of the target object. The second fuzzy mask image may be an image after fuzzy processing of the reverse mask image of the target object. A fuzzy may be the Gaussian fuzzy. For example, FIG. 3c is an example of the first fuzzy mask image, and FIG. 3d is an exemplary diagram of the second fuzzy mask image. For example, the way of fusing the second fuzzy mask image and the reverse mask image of the target object may be that: a maximum value of a pixel value of the second fuzzy mask image and a corresponding pixel value of the reverse mask image of the target object is taken, and the fused mask image is generated based on a maximum pixel value. For example, FIG. 3e is an exemplary diagram of a fused mask image in the embodiment. For example, the way of fusing the fused mask image and the first fuzzy mask image may be that: a minimum value of a pixel value of the fused mask image and a corresponding pixel value of the first fuzzy mask image is taken, and the second back illumination intensity image is generated based on a minimum pixel value. For example, FIG. 3f is an exemplary diagram of a second back illumination intensity image in the embodiment. In the embodiment, the second back illumination intensity image has an effect of defining a contour of the target object.

For example, the way of fusing the first back illumination intensity image and the second back illumination intensity image may be that: a pixel value of the first back illumination intensity image and a pixel value of the second back illumination intensity image are added, to obtain the target back illumination intensity image. For example, FIG. 3g is an exemplary diagram of a target back illumination intensity image in the embodiment. The way of fusing the target back illumination intensity image and the light source color may be that: the illumination intensity of the target back illumination intensity image is multiplied by the light source color, to obtain the back illumination image.

Optionally, the way of fusing the target object illumination image, the background region illumination image and the back illumination image, to obtain the target illumination image may be that: a relative position between the light source and a target object is determined based on the first angle information; and the target object illumination image, the background region illumination image and the back illumination image are fused based on the relative position, to obtain the target illumination image.

The relative positions include: the light source being located in front of the target object, the light source being located at a back of the target object, and the light source being located at a side of the target object. The first angle information is a point multiplication result of a normal vector of the target object and an illumination direction vector. The way of determining the relative position between the light source and the target object based on the first angle information may be that: in response to the first angle information glare being within (t, 1], that is, t<glare≤1, the light source is located in front of the target object; in response to the first angle information being within [−1,−t), that is, −1≤glare<−t, the light source is located at the back of the target object; and in response to the first angle information being within [−t, t], that is, −t≤glare≤t, the light source is located at the side of the target object, where t may be a value of 0-1, and for example, is set to be 0.1 or 0.2.

For example, the way of fusing the target object illumination image, the background region illumination image and the back illumination image based on the relative position, to obtain the target illumination image may be that: in response to the light source being located in front of the target object, the target object illumination image and the background region illumination image are fused, to obtain the target illumination image; in response to the light source being located at the back of the target object, the background region illumination image and the back illumination image are fused, to obtain the target illumination image; in response to the light source being located at the side of the target object, interpolating fusion is performed on the target object illumination image and the back illumination image, to obtain an intermediate illumination image; and the intermediate illumination image and the background region illumination image are fused, to obtain the target illumination image.

For example, the target object illumination image and the background region illumination image may be fused through the following step: a pixel value of the target object illumination image and a pixel value of the background region illumination image are added. The background region illumination image and the back illumination image may be fused through the following step: a pixel value of the background region illumination image and a pixel value of the back illumination image are added.

For example, the way of performing the interpolating fusion on the target object illumination image and the back illumination image may be that: a mapping relation between [−t, t] and [0, 1] is determined through interpolation operation; a target value corresponding to the first angle information is determined based on the mapping relation; a result of subtracting the target value from 1 is determined as a weighting coefficient of the target object illumination image; the target value is determined as a weighting coefficient of the back illumination image; and weighting computation is performed on the target object illumination image and the back illumination image based on the weighting coefficients, such that the intermediate illumination image is obtained. The way of fusing the intermediate illumination image and the background region illumination image may be that: a pixel value of the intermediate illumination image and a pixel value of the background region illumination image are added. In the embodiment, the target illumination image is determined based on the relative position between the light source and the target object, such that accuracy and authenticity of the target illumination image can be improved.

At S130, the target illumination image and the original image are fused, to obtain a target illumination effect image.

For example, the way of fusing the target illumination image and the original image may be that: a color value of the target illumination image and a color value of the original image are added.

Optionally, the method further includes the following steps: a gray image and a mask image of the local object of the original image are obtained; the gray image and the mask image of the local object are fused, to obtain a local object image; the light source color is adjusted based on the normal map, the viewing angle information and the light source position, to obtain a target illumination color; a set color and the target illumination color are fused based on the local object image, to obtain a local object illumination effect image; and the local object illumination effect image and the target object illumination image are fused, to obtain a updated target object illumination image.

The local object is an object composed of a local region of a target object. In the embodiment, assuming that the target object is a person, the local object is hairs.

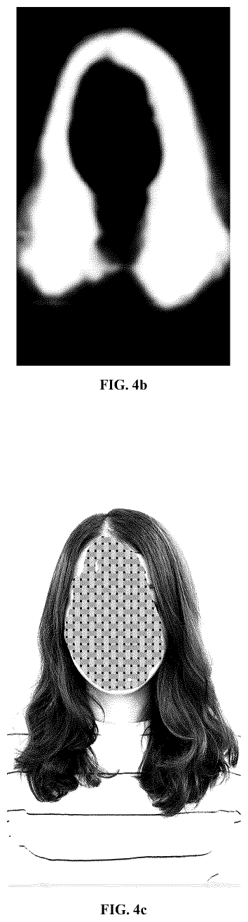

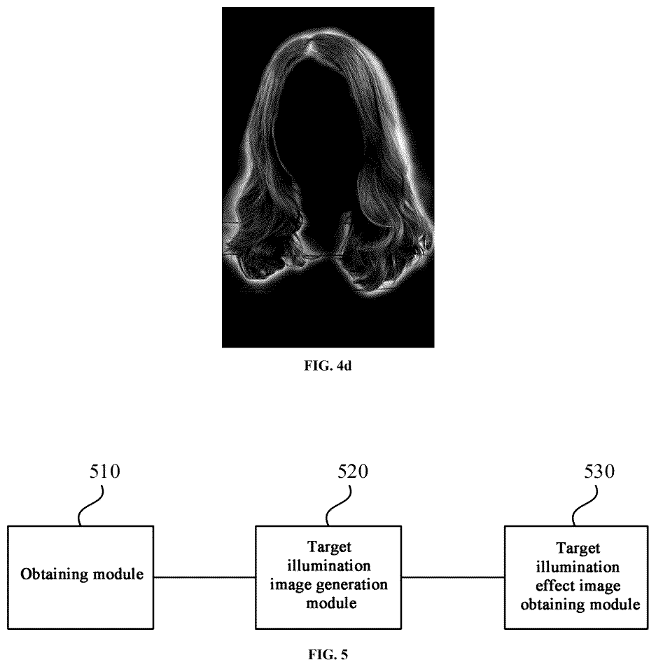

The way of obtaining the gray image of the original image may be that: gray processing is performed on the original image, to obtain the gray image. For example, FIG. 4a is an exemplary diagram of a gray image in the embodiment.

The way of obtaining the mask image of the local object of the original image may be that: the local object of the original image is identified, to obtain the mask image of the local object. For example, FIG. 4b is an exemplary diagram of a mask image of the local object in the embodiment.

For example, the way of fusing the gray image and the mask image of the local object, to obtain the local object image may be that: the gray image is smoothed, to obtain a smooth gray image; and the smooth gray image and the mask image of the local object are fused, to obtain a smooth local object image.

The way of smoothing the gray image may be that: a first difference between a gray value and a first set value is determined; a second difference between a second set value and the first set value is determined; a ratio of the first difference to the second difference is computed; the ratio between 0 and 1 is taken; Nth power processing is performed on the ratio, to obtain a processed gray value; and a smooth gray value is generated based on the processed gray value. The first set value may be 0, the second set value may be 0.5, and N may be 3. A formula for Nth power processing on the ratio may be expressed as x*x*(a−bx), where a and b are constants, and x is the ratio. For example, FIG. 4c is an exemplary diagram of a smooth gray image in the embodiment.

For example, the way of fusing the smooth gray image and the mask image of the local object may be that: a pixel value of the smooth gray image is multiplied by a pixel value of the mask image of the local object. For example, FIG. 4d is an exemplary diagram of a smooth local object image in the embodiment. In the embodiment, the gray image is smoothed, such that more details of a local object can be highlighted, and the local object can have an effect of highlighting. Regarding hairs of the embodiment, the gray image is smoothed, such that more detailed hairs can be obtained, and a more accurate illumination effect can be achieved.

For example, the way of adjusting the light source color based on the normal map, the viewing angle information and the light source position, to obtain a target illumination color may be that: a reflected illumination direction is determined based on the normal map and the light source position; third angle information between a viewing angle and the reflected illumination direction is determined; and the light source color is adjusted based on the third angle information, to obtain the target illumination color.

The reflected illumination direction may be understood as a direction of a reflected light. The process of determining the reflected illumination direction based on the normal map and the light source position may be that: the illumination direction vector is determined based on the light source position and the target object center; and the illumination direction vector and a normal direction vector are linearly computed, to obtain a reflected illumination direction vector. The way of linearly computing the illumination direction vector and the normal direction vector may be that: a point multiplication result of the illumination direction vector and the normal direction vector is computed; the point multiplication result, a set value and the normal direction vector are multiplied; and then the multiplied vector is subtracted from the illumination direction vector. The set value may be 2.

The way of determining the third angle information between the viewing angle and the reflected illumination direction may be that: a point multiplication result of the viewing angle direction vector and the reflected illumination direction vector is used as the third angle information.

The way of adjusting the light source color based on the third angle information, to obtain the target illumination color may be that: exponential operation is performed on the third angle information with a set highlight value; and an exponential operation result is multiplied by the light source color, to obtain the target illumination color. The set highlight value is a value set by a user. In the embodiment, the light source color is adjusted based on the third angle information, such that the local object can have an effect of highlighting.

Accordingly, the way of fusing the set color and the target illumination color based on the local object image, to obtain the local object illumination effect image may be that: the set color and the target illumination color are fused based on the smooth local object image, to obtain the local object illumination effect image.

The set color may be black, with a corresponding color value of (0, 0, 0). The way of fusing the set color and the target illumination color based on the smooth local object image may be that: a pixel value of the smooth local object image is used as a weighting coefficient of the target illumination color; a result of subtracting the pixel value of the smooth local object image from 1 is used as a weighting coefficient of the set color; and weighted summation is performed on the set color and the target illumination color based on the weighting coefficients.

For example, the way of fusing the local object illumination effect image and the target object illumination image may be that: a pixel value of the local object illumination effect image and a corresponding pixel value of the target object illumination image are added.

Accordingly, the way of fusing the target object illumination image, the background region illumination image and the back illumination image, to obtain the target illumination image may be that: the updated target object illumination image, background region illumination image and back illumination image are fused, to obtain the target illumination image.

According to the technical solution of the embodiment of the disclosure, the current light source information, the normal map of the original image and the mask image of the target object are obtained, where the light source information includes the light source color, the light source position, and the illumination intensity; the target illumination image is generated based on the normal map, the mask image of the target object, and the light source information; and the target illumination image and the original image are fused, to obtain the target illumination effect image. In the method for generating an effect image according to the embodiment of the disclosure, the target illumination image is generated based on the normal map, the mask image of the target object, and the light source information, such that an effect image having a lighting effect can be generated, and a display content of the image can be enriched.

FIG. 5 is a schematic structural diagram of an apparatus for generating an effect image according to an embodiment of the disclosure. As shown in FIG. 5, the apparatus includes: an obtaining module 510, a target illumination image generation module 520, and a target illumination effect image obtaining module 530.

The obtaining module 510 is configured to obtain current light source information, a normal map of an original image, and a mask image of the target object, where the light source information includes a light source color, a light source position, and an illumination intensity.

The target illumination image generation module 520 is configured to generate a target illumination image based on the normal map, the mask image of the target object, and the light source information.

The target illumination effect image obtaining module 530 is configured to fuse the target illumination image and the original image, to obtain a target illumination effect image.

Optionally, the target illumination image generation module 520 is further configured to: generate a target object illumination image based on the normal map, the light source information, and the mask image of the target object; generate a background region illumination image based on the light source information and the mask image of the target object; generate a back illumination image based on the normal map and the mask image of the target object; and fuse the target object illumination image, the background region illumination image and the back illumination image, to obtain the target illumination image.

Optionally, the target illumination image generation module 520 is further configured to: determine a first illumination intensity image based on the normal map and the light source information; fuse the first illumination intensity image and the light source color, to obtain an initial illumination image; and fuse the initial illumination image and the mask image of the target object, to obtain the target object illumination image.

Optionally, the target illumination image generation module 520 is further configured to: determine first angle information between an incident light and a pixel point in the original image based on the normal map and the light source information; determine attenuation information based on a distance between a light source and the pixel point in the original image; adjust the illumination intensity based on the first angle information and the attenuation information, to obtain a target intensity of the pixel point; and generate the first illumination intensity image based on the target intensity of the pixel point.

Optionally, the target illumination image generation module 520 is further configured to: obtain a distance between a light source and the pixel point in the original image; generate a second illumination intensity image based on the distance and the illumination intensity; fuse the second illumination intensity image and the mask image of the target object, to obtain an illumination intensity mask image; and fuse a set color and the light source color based on the illumination intensity mask image, to obtain the background region illumination image.

Optionally, the target illumination image generation module 520 is further configured to: determine a first back illumination intensity image based on the normal map, the mask image of the target object, and viewing angle information; perform reverse processing on the mask image of the target object, to obtain a reverse mask image of the target object; generate a second back illumination intensity image based on the mask image of the target object and the reverse mask image of the target object; fuse the first back illumination intensity image and the second back illumination intensity image, to obtain a target back illumination intensity image; and fuse the target back illumination intensity image and the light source color, to obtain the back illumination image.

Optionally, the target illumination image generation module 520 is further configured to: determine second angle information between normal information of a plurality of pixel points in the normal map and the viewing angle information; determine an initial back illumination intensity of the plurality of pixel points based on the second angle information; generate an initial back illumination intensity image based on the initial back illumination intensity; and fuse the initial back illumination intensity image and the mask image of the target object, to obtain the first back illumination intensity image.

Optionally, the target illumination image generation module 520 is further configured to: perform fuzzy processing on the mask image of the target object and the reverse mask image of the target object separately, to obtain a first fuzzy mask image and a second fuzzy mask image; fuse the second fuzzy mask image and the reverse mask image of the target object, to obtain a fused mask image; and fuse the fused mask image and the first fuzzy mask image, to obtain the second back illumination intensity image.

Optionally, the apparatus further includes: a target object illumination image updating module configured to: obtain a gray image and a mask image of the local object of the original image, where a local object is an object composed of a local region of a target object; fuse the gray image and the mask image of the local object, to obtain a local object image; adjust the light source color based on the normal map, the viewing angle information and the light source position, to obtain a target illumination color; fuse a set color and the target illumination color based on the local object image, to obtain a local object illumination effect image; and fuse the local object illumination effect image and the target object illumination image, to obtain a updated target object illumination image.

Optionally, the target object illumination image updating module is further configured to: smooth the gray image, to obtain a smooth gray image; fuse the smooth gray image and the mask image of the local object, to obtain a smooth local object image; and fuse the set color and the target illumination color based on the smooth local object image, to obtain the local object illumination effect image.

Optionally, the target object illumination image updating module is further configured to: determine a reflected illumination direction based on the normal map and the light source position; determine third angle information between the viewing angle information and the reflected illumination direction; and adjust the light source color based on the third angle information, to obtain the target illumination color.

Optionally, the target illumination image generation module 520 is further configured to: determine a relative position between the light source and a target object based on the first angle information, where the relative positions include: the light source being located in front of the target object, the light source being located at a back of the target object, and the light source being located at a side of the target object; and fuse the target object illumination image, the background region illumination image and the back illumination image based on the relative position, to obtain the target illumination image.

Optionally, the target illumination image generation module 520 is further configured to: in response to the light source being located in front of the target object, fuse the target object illumination image and the background region illumination image, to obtain the target illumination image; in response to the light source being located at the back of the target object, fuse the background region illumination image and the back illumination image, to obtain the target illumination image; and in response to the light source being located at the side of the target object, perform interpolating fusion on the target object illumination image and the back illumination image, to obtain an intermediate illumination image; and fuse the intermediate illumination image and the background region illumination image, to obtain the target illumination image.

The apparatus for generating an effect image according to the embodiment of the disclosure may execute the method for generating an effect image according to any one of the embodiments of the disclosure, and has corresponding functional modules and effects corresponding to execution of the method.

It should be noted that all units and modules included in the apparatus are merely divided based on a functional logic, but are not limited to the above division, as long as the corresponding functions may be achieved. In addition, names of all functional units are merely for convenience of mutual distinguishing, and are not used to limit the protection scope of the embodiments of the disclosure.

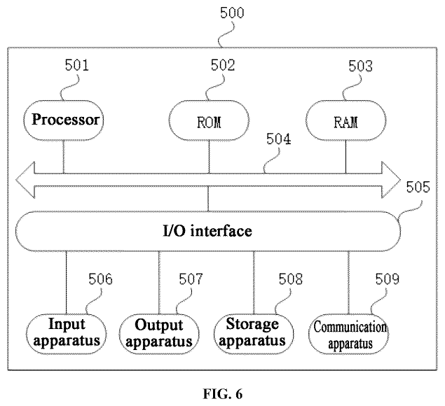

FIG. 6 is a schematic structural diagram of an electronic device according to an embodiment of the disclosure. With reference to FIG. 6, FIG. 6 shows a schematic structural diagram of an electronic device (for example, a terminal device or a server in FIG. 6) 500 suitable for implementing an embodiment of the disclosure. The electronic device in the embodiment of the disclosure may be, but is not limited to, a mobile terminal such as a mobile phone, a notebook computer, a digital broadcast receiver, a personal digital assistant (PDA), a portable android device (PAD), a portable media player (PMP), or a vehicular terminal (for example, a vehicular navigation terminal); and a fixed terminal such as a digital television (TV) or a desktop computer. The electronic device shown in FIG. 6 is only illustrative, and is not intended to limit functions and a use scope of the embodiments of the disclosure.

As shown in FIG. 6, the electronic device 500 may include a processor (for example, a central processing unit or a graphics processing unit) 501. The processor 501 may execute various appropriate actions and processing according to a program stored in a read-only memory (ROM) 502 or a program loaded from a storage apparatus 508 to a random access memory (RAM) 503. The RAM 503 further stores various programs and data required for operations of the electronic device 500. The processor 501, the ROM 502 and the RAM 503 are connected to one another by means of a bus 504. An input/output (I/O) interface 505 is further connected to the bus 504.

Generally, the following apparatuses may be connected to the I/O interface 505: an input apparatus 506 including, for example, a touch screen, a touch pad, a keyboard, a mouse, a camera, a microphone, an accelerometer, a gyroscope, etc.; an output apparatus 507 including, for example, a liquid crystal display (LCD), a speaker, a vibrator, etc.; the storage apparatus 508 including, for example, a magnetic tape, a hard disk, etc.; and a communication apparatus 509. The communication apparatus 509 may allow the electronic device 500 to be in wireless or wired communication with other devices for data exchange. Although FIG. 6 shows the electronic device 500 including various apparatuses, it should be understood that not all the apparatuses shown are required to be implemented or included. More or fewer apparatuses may be alternatively implemented or included.

Particularly, according to the embodiment of the disclosure, the process described above with reference to the flow diagram may be implemented to be a computer software program. For example, an embodiment of the disclosure includes a computer program product, which includes a computer program carried on a non-transitory computer-readable medium. The computer program includes a program code configured to execute the method shown in the flow diagram. In such an embodiment, the computer program may be downloaded and installed from a network through the communication apparatus 509, or installed from the storage apparatus 508, or installed from the ROM 502. The computer program executes the functions defined in the method according to the embodiment of the disclosure when being executed by the processor 501.

The electronic device according to the embodiment of the disclosure belongs to the same concept as the method for generating an effect image according to the above embodiments. Reference may be made to the above embodiments for technical details not described in detail in the embodiment. The embodiment has the same effects as the above embodiments.

An embodiment of the disclosure provides a computer-readable storage medium, which stores a computer program. The computer program implements the method for generating an effect image according to the embodiment when being executed by a processor.

It should be noted that the computer-readable storage medium described in the disclosure may be a computer-readable signal medium, or a computer-readable storage medium, or any combination thereof. For example, the computer-readable storage medium may be, but is not limited to, an electronic, magnetic, optical, electromagnetic, infrared, or semiconductor system, apparatus, or device, or any suitable combination thereof. Examples of the computer-readable storage medium may include, but are not limited to, an electrical connection having at least one wire, a portable computer disk, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination thereof. In the disclosure, the computer-readable storage medium may be any tangible medium including or storing a program. The program may be used by or in combination with an instruction execution system, apparatus or device. In the disclosure, the computer-readable signal medium may include a data signal propagated in a baseband or as part of a carrier, in which a computer-readable program code is carried. The propagated data signal may have a plurality of forms, including, but not limited to, an electromagnetic signal, an optical signal, or any suitable combination thereof. The computer-readable signal medium may further be any computer-readable storage medium other than the computer-readable storage medium. The computer-readable signal medium may send, propagate or transmit a program used by or in combination with an instruction execution system, apparatus or device. The program code included in the computer-readable storage medium may be transmitted by any suitable medium, including, but not limited to, an electric wire, an optical cable, radio frequency (RF), or any suitable combination thereof.

In some embodiments, a client and a server may be in communication with each other with any currently known or future-developed network protocol, for example, a hypertext transfer protocol (HTTP), and may be interconnected with digital data communication (for example, a communication network) in any form or medium. Examples of the communication network include a local area network (LAN), a wide area network (WAN), the internet work (for example, the Internet), an end-to-end network (for example, an ad hoc end-to-end network), and any currently-known or future-developed networks.

The computer-readable storage medium may be included in the electronic device, or may exist independently without being assembled into the electronic device.

The computer-readable medium carries at least one program. The at least one program, when executed by the electronic device, causes the electronic device to: obtain current light source information, a normal map of an original image, and a mask image of the target object, where the light source information includes a light source color, a light source position, and an illumination intensity; generate a target illumination image based on the normal map, the mask image of the target object, and the light source information; and fuse the target illumination image and the original image, to obtain a target illumination effect image.

A computer program code configured to execute an operation of the disclosure may be written in at least one programming language or a combination thereof. The programming languages include, but are not limited to, object-oriented programming languages such as Java, Smalltalk, and C++, and further include conventional procedural programming languages such as “C” or similar programming languages. The program codes may be completely executed on a computer of the user, partially executed on the computer of the user, executed as an independent software package, partially executed on the computer of the user and a remote computer separately, or completely executed on the remote computer or the server. In the case of involving the remote computer, the remote computer may be connected to the computer of the user through any type of network, including a local area network (LAN) or a wide area network (WAN), or may be connected to an external computer (for example, through the Internet provided by an Internet service provider).

Flow diagrams and block diagrams in the accompanying drawings illustrate architectures, functions and operations that may be implemented by the systems, the methods and the computer program products according to various embodiments of the disclosure. In view of that, each block in the flow diagrams or block diagrams may represent a module, a program segment, or part of a code, which includes at least one executable instruction configured to implement specified logic functions. It should further be noted that in some alternative embodiments, the functions noted in the blocks may also occur in an order different from that in the accompanying drawings. For example, the functions represented by two continuous blocks may be actually implemented basically in parallel, or may be implemented in reverse orders, which depends on the involved functions. It should further be noted that each block in the block diagrams and flow diagrams and combinations of the blocks in the block diagrams and the flow diagrams may be implemented with dedicated hardware-based systems that implement the specified functions or operations, or may be implemented with combinations of dedicated hardware and computer instructions.

The units involved in the embodiment of the disclosure may be implemented by software or hardware. Names of the units do not limit the units themselves. For example, a first obtaining unit may also be described as “a unit obtaining at least two Internet protocol addresses”.

The functions described herein may be at least partially executed by at least one hardware logic component. For example, for the non-limitative purposes, illustrative types of hardware logic components that may be used include: a field programmable gate array (FPGA), an application specific integrated circuit (ASIC), application specific standard parts (ASSPs), a system on chip (SOC), a complex programmable logic device (CPLD), etc.

In the context of the disclosure, the machine-readable storage medium may be a tangible medium, which may include or store a program used by or used in combination with an instruction execution system, apparatus or device. The machine-readable storage medium may be a machine-readable signal medium or a machine-readable storage medium. The machine-readable storage medium may include, but is not limited to, an electronic, magnetic, optical, electromagnetic, infrared, or semiconductor system, apparatus, or device, or any suitable combination thereof. Examples of the machine-readable storage medium include an electrical connection based on at least one wire, a portable computer disk, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination thereof.

1. A method for generating an effect image, comprising:
obtaining current light source information, a normal map of an original image, and a mask image of a target object, wherein the light source information comprises a light source color, a light source position, and an illumination intensity;
generating a target illumination image based on the normal map, the mask image of the target object, and the light source information; and
fusing the target illumination image and the original image, to obtain a target illumination effect image.

2. The method according to claim 1, wherein generating the target illumination image based on the normal map, the mask image of the target object, and the light source information comprises:
generating a target object illumination image based on the normal map, the light source information, and the mask image of the target object;
generating a background region illumination image based on the light source information and the mask image of the target object;
generating a back illumination image based on the normal map and the mask image of the target object; and
fusing the target object illumination image, the background region illumination image and the back illumination image, to obtain the target illumination image.

3. The method according to claim 2, wherein generating the target object illumination image based on the normal map, the light source information, and the mask image of the target object comprises:
determining a first illumination intensity image based on the normal map and the light source information;
fusing the first illumination intensity image and the light source color, to obtain an initial illumination image; and
fusing the initial illumination image and the mask image of the target object, to obtain the target object illumination image.

4. The method according to claim 3, wherein determining the first illumination intensity image based on the normal map and the light source information comprises:
determining first angle information between an incident light and a pixel point in the original image based on the normal map and the light source information;
determining intensity attenuation information based on a distance between a light source and the pixel point in the original image;
adjusting the illumination intensity based on the first angle information and the intensity attenuation information, to obtain a target intensity of the pixel point; and
generating the first illumination intensity image based on the target intensity of the pixel point.

5. The method according to claim 2, wherein generating the background region illumination image based on the light source information and the mask image of the target object comprises:
obtaining a distance between a light source and a pixel point in the original image;
generating a second illumination intensity image based on the distance and the illumination intensity;
fusing the second illumination intensity image and the mask image of the target object, to obtain an illumination intensity mask image; and
fusing a set color and the light source color based on the illumination intensity mask image, to obtain the background region illumination image.

6. The method according to claim 2, wherein generating the back illumination image based on the normal map and the mask image of the target object comprises:
determining a first back illumination intensity image based on the normal map, the mask image of the target object, and viewing angle information;
preforming reverse processing on the mask image of the target object, to obtain a reverse mask image of the target object;
generating a second back illumination intensity image based on the mask image of the target object and the reverse mask image of the target object;
fusing the first back illumination intensity image and the second back illumination intensity image, to obtain a target back illumination intensity image; and
fusing the target back illumination intensity image and the light source color, to obtain the back illumination image.

7. The method according to claim 6, wherein determining the first back illumination intensity image based on the normal map, the mask image of the target object, and the viewing angle information comprises:
determining second angle information between normal information of each pixel point in the normal map and the viewing angle information;
determining an initial back illumination intensity of each pixel point based on the second angle information;
generating an initial back illumination intensity image based on the initial back illumination intensity of each pixel point; and
fusing the initial back illumination intensity image and the mask image of the target object, to obtain the first back illumination intensity image.

8. The method according to claim 6, wherein generating the second back illumination intensity image based on the mask image of the target object and the reverse mask image of the target object comprises:
performing fuzzy processing on the mask image of the target object and the reverse mask image of the target object, respectively, to obtain a first fuzzy mask image and a second fuzzy mask image;
fusing the second fuzzy mask image and the reverse mask image of the target object, to obtain a fused mask image; and
fusing the fused mask image and the first fuzzy mask image, to obtain the second back illumination intensity image.

9. The method according to claim 2, further comprising:
obtaining a gray image and a mask image of a local object of the original image, wherein the local object is an object composed of a local region of the target object;
fusing the gray image and the mask image of the local object, to obtain a local object image;
adjusting the light source color based on the normal map, viewing angle information and the light source position, to obtain a target illumination color;
fusing a set color and the target illumination color based on the local object image, to obtain a local object illumination effect image; and
fusing the local object illumination effect image and the target object illumination image, to obtain a updated target object illumination image.

10. The method according to claim 9, wherein fusing the gray image and the mask image of the local object, to obtain the local object image comprises:
smoothing the gray image, to obtain a smooth gray image; and
fusing the smooth gray image and the mask image of the local object, to obtain a smooth local object image; and
wherein fusing the set color and the target illumination color based on the local object image, to obtain the local object illumination effect image comprises:
fusing the set color and the target illumination color based on the smooth local object image, to obtain the local object illumination effect image.

11. The method according to claim 9, wherein adjusting the light source color based on the normal map, the viewing angle information and the light source position, to obtain the target illumination color comprises:
determining a reflected illumination direction based on the normal map and the light source position;
determining third angle information between the viewing angle information and the reflected illumination direction; and
adjusting the light source color based on the third angle information, to obtain the target illumination color.

12. The method according to claim 4, wherein fusing the target object illumination image, the background region illumination image and the back illumination image, to obtain the target illumination image comprises:
determining a relative position between the light source and the target object based on the first angle information, wherein the relative position comprises the light source being located in front of the target object, the light source being located at a back of the target object, or the light source being located at a side of the target object; and
fusing the target object illumination image, the background region illumination image and the back illumination image based on the relative position, to obtain the target illumination image.

13. The method according to claim 12, wherein fusing the target object illumination image, the background region illumination image and the back illumination image based on the relative position, to obtain the target illumination image comprises:
in response to the light source being located in front of the target object, fusing the target object illumination image and the background region illumination image, to obtain the target illumination image;
in response to the light source being located at the back of the target object, fusing the background region illumination image and the back illumination image, to obtain the target illumination image; and
in response to the light source being located at the side of the target object, interpolating-fusing the target object illumination image and the back illumination image, to obtain an intermediate illumination image; and fusing the intermediate illumination image and the background region illumination image, to obtain the target illumination image.

14. (canceled)

15. An electronic device, comprising:
at least one processor; and
a storage apparatus configured to store at least one program which, when executed by the at least one processor, causes the at least one processor to:
obtain current light source information, a normal map of an original image, and a mask image of a target object, wherein the light source information comprises a light source color, a light source position, and an illumination intensity;
generate a target illumination image based on the normal map, the mask image of the target object, and the light source information; and
fuse the target illumination image and the original image, to obtain a target illumination effect image.

16. A non-transitory storage medium comprising a computer-executable instruction which, when executed by a processor of a computer, causes the processor of the computer to:
obtain current light source information, a normal map of an original image, and a mask image of a target object, wherein the light source information comprises a light source color, a light source position, and an illumination intensity;
generate a target illumination image based on the normal map, the mask image of the target object, and the light source information; and
fuse the target illumination image and the original image, to obtain a target illumination effect image.

17. The electronic device according to claim 15, wherein to generate the target illumination image based on the normal map, the mask image of the target object, and the light source information, the at least one program causes the at least one processor to:
generate a target object illumination image based on the normal map, the light source information, and the mask image of the target object;
generate a background region illumination image based on the light source information and the mask image of the target object;
generate a back illumination image based on the normal map and the mask image of the target object; and
fuse the target object illumination image, the background region illumination image and the back illumination image, to obtain the target illumination image.

18. The electronic device according to claim 17, wherein to generate the target object illumination image based on the normal map, the light source information, and the mask image of the target object, the at least one program causes the at least one processor to:
determine a first illumination intensity image based on the normal map and the light source information;
fuse the first illumination intensity image and the light source color, to obtain an initial illumination image; and
fuse the initial illumination image and the mask image of the target object, to obtain the target object illumination image.

19. The electronic device according to claim 18, wherein to determine the first illumination intensity image based on the normal map and the light source information, the at least one program causes the at least one processor to:
determine first angle information between an incident light and a pixel point in the original image based on the normal map and the light source information;
determine intensity attenuation information based on a distance between a light source and the pixel point in the original image;
adjust the illumination intensity based on the first angle information and the intensity attenuation information, to obtain a target intensity of the pixel point; and
generate the first illumination intensity image based on the target intensity of the pixel point.

20. The electronic device according to claim 17, wherein to generate the background region illumination image based on the light source information and the mask image of the target object, the at least one program causes the at least one processor to:
obtain a distance between a light source and a pixel point in the original image;
generate a second illumination intensity image based on the distance and the illumination intensity;
fuse the second illumination intensity image and the mask image of the target object, to obtain an illumination intensity mask image; and
fuse a set color and the light source color based on the illumination intensity mask image, to obtain the background region illumination image.

21. The electronic device according to claim 17, wherein to generating the back illumination image based on the normal map and the mask image of the target object, the at least one program causes the at least one processor to:
determine a first back illumination intensity image based on the normal map, the mask image of the target object, and viewing angle information;
preform reverse processing on the mask image of the target object, to obtain a reverse mask image of the target object;
generate a second back illumination intensity image based on the mask image of the target object and the reverse mask image of the target object;
fuse the first back illumination intensity image and the second back illumination intensity image, to obtain a target back illumination intensity image; and
fuse the target back illumination intensity image and the light source color, to obtain the back illumination image.
